(19) United States
(12) Patent Application Publication
(10) Pub. No.: US 2006/0241899 A1
(43) Pub. Date: Oct. 26, 2006

(54) SYSTEM AND METHOD FOR TRANSFORMING THREE-DIMENSIONAL MEASUREMENT PROGRAMS

(76) Inventor: Zhong-Kui Yuan, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,320

(22) Filed: Mar. 16, 2006

(30) Foreign Application Priority Data
Apr. 9, 2005 (CN) 200510034117.2

(51) Int. Cl. G06F 15/00

(52) U.S. Cl. 702/152

(57) ABSTRACT

The present invention provides a method for transforming 3-D measurement programs. The method includes the steps of: loading a 3-D measurement program; determining a transforming direction of the 3-D measurement program; establishing a transforming sequence; transforming each part of the 3-D measurement program; and storing the transformed 3-D measurement program as a file. A related system is also provided.

### FIELD OF THE INVENTION

The present invention generally relates to systems and methods for transforming computer programs, and more particularly to a system and method for transforming computer programs about measurement.

### DESCRIPTION OF RELATED ART

Three-Dimensional (hereinafter, “3-D”) measurement is widely used in manufacture industry by operators for detecting new developed molds. There are mainly two kinds of 3-D measurement machines. One kind is developed by IMS (International Measurement System), a company of Britain, in which only Virtual DMIS (Dimensional Measurement Interface Standard) programs are applicable, and the other kind is developed by B&S (Brown & Sharpe), a company of United States, in which only PC-DMIS programs are applicable. DMIS forms the basis of the two programming languages of PC-DMIS and Virtual DMIS.

The two kinds of 3-D measurement machines identify measurement programs written in each designated languages, i.e., Virtual DMIS and PC-DMIS respectively. For example, a 3-D measurement machine which designates the language of Virtual DMIS for programs can not identify programs written in the language of PC-DMIS. As a result, existing measurement programs haven't been used adequately. On the other hand, program developers may need to express one measurement method in two programming languages, PC-DMIS and Virtual DMIS, which would result in increased human resource cost.

China Patent Application. No. 02809740, entitled “method and system for transforming legacy software applications into object-oriented systems” discloses a method for transforming a procedural program having procedural language codes into an object-oriented program. However, the system and method does not refer to transformation of 3-D measurement programs written in different programming languages.

What is needed, therefore, is a system and method for transforming 3-D measurement programs written in a language into corresponding 3-D measurement programs written in another language in order to improve usage of existing 3-D measurement programs and decrease human resource cost.

### SUMMARY OF INVENTION

A system for transforming 3-D measurement programs in accordance with a preferred embodiment can be implemented as described herein. The system includes: a first three-dimensional measurement machine applicable to a first measurement program, a second three-dimensional measurement machine applicable to a second measurement program, and a three-dimensional measurement program transforming device. The three-dimensional measurement program transforming device includes: a measurement program loading module for loading the first measurement program; a parameter setting transforming module for transforming parameter settings of the first measurement program to parameter settings of the second measurement program; a coordinate element transforming module for transforming coordinate elements of the first measurement program to coordinate elements of the second measurement program; and a geometry element transforming module for transforming geometry elements of the first measurement program to geometry elements of the second measurement program.

Another embodiment provides a method for transforming 3-D measurement programs by utilizing the above system. The method can be used for transforming a first measurement program in a first three-dimensional measurement machine to a second measurement program in a second three-dimensional measurement machine, which includes the steps: (a) loading the first measurement program; (b) establishing a transforming sequence; and (c) transforming each part of the first measurement program to corresponding part of the second measurement program.

The invention can act as a transforming bridge between different 3-D measurement programs, improve the utilization ratio of the existing measurement programs, and reduce human resource cost.

Other advantages and novel features of the embodiments will be drawn from the following detailed description with reference to the attached drawings, in which:

### BRIEF DESCRIPTION OF DRAWINGS

FIG. 1 is a schematic diagram of hardware configuration of a system for transforming 3-D measurement programs according to a preferred embodiment;

FIG. 2 is a diagram of function units of a 3-D measurement program transforming device of the system of FIG. 1; and

FIG. 3 is a flowchart of a preferred method for transforming 3-D measurement programs by utilizing the system of FIG. 1.

### DETAILED DESCRIPTION

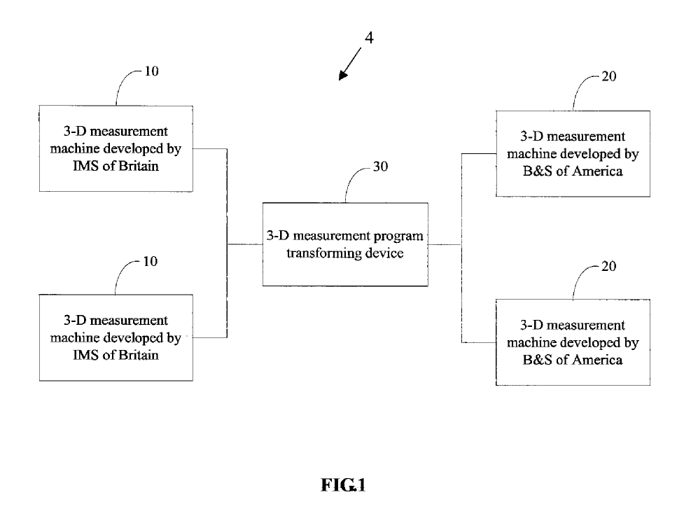

FIG. 1 is a schematic diagram of hardware configuration of a system for transforming 3-D measurement programs (hereinafter, “the system 4”) according to a preferred embodiment. The system 4 includes at least two 3-D measurement machines and a 3-D measurement program transforming device 30 (hereinafter, “the device 30”). The 3-D measurement machines are different from each other. For example, one of the 3-D measurement machines may be developed by IMS (International Measurement System) of Britain (hereinafter, “the machine 10”), in which only Virtual DMIS (Dimensional Measurement Interface Standard) programs are applicable, and one may be developed by B&S (Brown & Sharpe) of the United States (hereinafter, “the machine 20”), in which only PC-DMIS programs are applicable. The device 30 can transform a Virtual DMIS program to a corresponding PC-DMIS program or reversely.

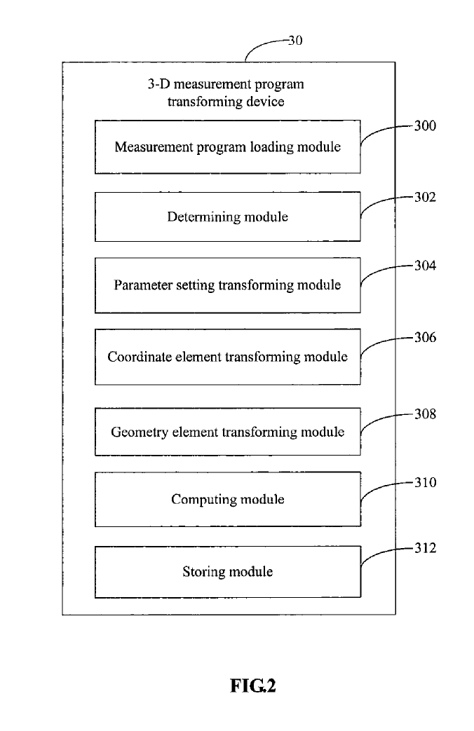

FIG. 2 is a diagram of function units of the device 30 of FIG. 1. The device 30 includes: a measurement program loading module 300, a determining module 302, a parameter setting transforming module 304, a coordinate element transforming module 306, a geometry element transforming module 308, a computing module 310, and a storing module 312.

The measurement program loading module 300 is used for loading a 3-D measurement program from a storage which may be in or out of the device 30 (not shown).

The determining module 302 is used for determining whether the loaded 3-D measurement program in a first programming language needs to be transformed to a corresponding 3-D measurement program in a second programming language. For example, the determining module 302 determines whether a loaded Virtual DMIS program needs to be transformed to a corresponding PC-DMIS program, or whether a loaded PC-DMIS program needs to be transformed to a corresponding Virtual DMIS program.

The parameter setting transforming module 304 is used for transforming parameter settings of the loaded 3-D measurement program in the first programming language to parameter settings of a 3-D measurement program in the second programming language. The parameters typically include work planes, measurement modes, coordinate call parameters, probe settings, and so on.

The coordinate element transforming module 306 is used for transforming coordinate elements of the loaded 3-D measurement program to coordinate elements of the 3-D measurement program in the second programming language. The coordinate elements may include a reference frame.

The geometry element transforming module 308 is used for transforming geometry elements of the loaded 3-D measurement program to geometry elements of the 3-D measurement program in the second programming language. The geometry elements may include dots, lines, planes, circles, cylinders, tapers and spheres.

The computing module 310 is used for computing a height of a clear plane in 3-D measurement programs. The height of a clear plane in different 3-D measurement programs has different definitions. In a Virtual DMIS program, it represents a distance from the clear plane to a measured geometry element such as a plane, whereas in a PC-DMIS program, it represents a distance from the clear plane to an origin of a reference frame at which a measured geometry element is located.

The storing module 312 is used for storing the transformed 3-D measurement program as a file in the storage.

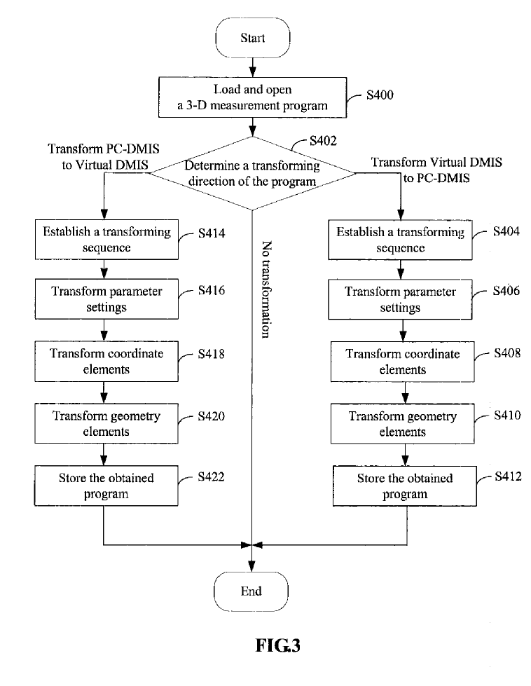

FIG. 3 is a flowchart of a preferred method for transforming a 3-D measurement program by utilizing the system 4 of FIG. 1. In step S400, the measurement program loading module 300 loads the 3-D measurement program into the device 30. In step S402, the determining module 302 determines whether the 3-D measurement program needs to be transformed to a corresponding 3-D measurement program in another programming language. If the 3-D measurement program does not need to be transformed, the procedure ends. If the 3-D measurement program is a Virtual DMIS program, and is to be applied in a machine 20 developed by B&S of the United States, the program needs to be transformed to a corresponding PC-DMIS program, then the procedure goes to step S404 in order to establish a transforming sequence. In this preferred embodiment, the parameter settings of the loaded 3-D measurement program are transformed first, then the coordinate elements, and at last the geometry elements.

In step S406, the parameter setting transforming module 304 transforms the parameter settings of the loaded Virtual DMIS program to parameter settings of the PC-DMIS program. The transformation is based on expression manners of parameter names and parameter values in the two programs. For example, the parameter name of a work plane is expressed by “WKPLAN” in the Virtual DMIS program, and by “WORKPLANE” in the PC-DMIS program; a called reference frame is expressed by “RECALL/D” in the Virtual DMIS program, and by “RECALL/ALIGNMENT,INTERNAL” in the PC-DMIS program; and a measurement mode is expressed by “MODE” both in the Virtual DMIS program and PC-DMIS program. Accordingly, the expression manners of each parameter value are different in the Virtual DMIS program and PC-DMIS program. For example, if an XY plane is selected as a work plane in measuring, the work plane can be expressed by “WKPLAN/XYPLAN” in the Virtual DMIS program, and by “WORKPLANE/ZPLUS” in the PC-DMIS program. For another example, if the manual mode is selected in measuring, it can be expressed by “MODE/MAN” in the Virtual DMIS program, and by “MODE/MANUAL” in the PC-DMIS program. For a third example, if the original reference frame of the measurement machine is required to be called in measuring, it can be expressed by “RECALL/D(MCS)” in the Virtual DMIS program, and by “RECALL/ALIGNMENT,INTERNAL,STARTUP” in the PC-DMIS program. “MCS” and “STARTUP” represent a parameter value of the original reference frame in the Virtual DMIS program and PC-DMIS program respectively.

The transformation of the parameter settings in step S406 includes the transformation of a height of a clear plane. The height of the clear plane in different 3-D measurement programs has different definitions. In the Virtual DMIS program, it represents a distance from the clear plane to a measured geometry element, whereas in the PC-DMIS program, it represents a distance from the clear plane to an origin of a reference frame at which a measured geometry is located. Take the transformation of “SNSET/CLRSRF,FA(PL1), 25.000000” in the Virtual DMIS program to the PC-DMIS program for example, PL1 is a measured plane which works as a clear plane, and the number 25.000000 represents a height of the clear plane. First, the direction and coordinates values of PL1 in the Virtual DMIS program should be confirmed. Supposing that the direction of PL1 is plus, the clear plane setting can be expressed by “CLEARP/ZPLUS,25+Z0, ZPLUS,0” in the PC-DMIS program; if the direction of PL1 is minus, the clear plane setting can be expressed by “CLEARP/ZPLUS,−25+Z0, ZPLUS,0” in the PC-DMIS program, in which Z0 is the Z-coordinate value of PL1.

In step S408, the coordinate element transforming module 306 transforms the coordinate elements of the loaded Virtual DMIS program to coordinate elements of the PC-DMIS program. For example, if a reference frame named PC1 is created in the loaded Virtual DMIS program, the sentence can be expressed as follows: D(PC1)=DATSET/FA(PL1),ZDIR,ZORIG,FA(LN1),XDIR,YORIG,FA(PT1),XORIG. Wherein, D(PC1) represents definition of a reference frame named PC1; DATSET represents creation of the reference frame; FA(PL1),ZDIR and ZORIG represent utilizing PL1 as a coordinate plane to correct the direction of Z, and setting the direction of Z to zero; FA(LN1),XDIR,and YORIG represent utilizing a line LN1 to correct the direction of X, and setting the direction of Y to zero; FA(PT1) and XORIG represent setting the direction of X to zero at a measurement point PT1. As a result, corresponding sentences in the PC-DMIS program are presented as follows:

PC1=ALIGNMENT/START,RECALL:STARTUP,LIST=YES ALIGNMENT/LEVEL,ZPLUS,PL1 ALIGNMENT/TRANS,ZAXIS,PL1 ALIGNMENT/ROTATE,XPLUS,TO,LN1,ABOUT,ZPLUS ALIGNMENT/TRANS,YAXIS,LN1 ALIGNMENT/TRANS,XAXIS,PT1 ALIGNMENT/END Wherein, ALIGNMENT represents creation of a reference frame.

In step S410, the geometry element transforming module 308 transforms the geometry elements of the loaded Virtual DMIS program to geometry elements of the PC-DMIS program. The geometry elements may include: dots, lines, planes, circles, cylinders, tapers and spheres. For example, the following sentences in the Virtual DMIS program can be used to create a dot with coordinates

(372.891758,413.420971,123.426070):F(PT1)=FEAT/POINT,CART,372.891758,413.420971,123.4260 70,-0.000132,-0.000601,0.999999811 MEAS/POINT,F(PT1),1 PTM EAS/CART,460.586074,429.983239,123.450448,-0.000132,-0.000601,0.999999811 ENDMES Corresponding sentences in the PC-DMIS program are presented as follows: PT1=FEAT/POINT,RECT THEO/372.891758,413.420971,123.426070,-0.000132,-0.000601,0.999999811 ACTL/372.891758,413.420971,123.426070,-0.000132,-0.000601,0.999999811 MEAS/POINT,1 HIT/BASIC,460.586074,429.983239,123.450448,-0.000132,-0.000601,1.000000,460.586074,429.983239,123.450448,USE THEO=YES ENDMEAS/

In step S412, the storing module 312 stores the transformed program as a file in the storage.

In step S402, if the 3-D measurement program is a PC-DMIS program, and is to be applied in a machine 10 developed by IMS of Britain, the program needs to be transformed to a corresponding Virtual DMIS program, then the procedure performs steps S414, S416, S418, S420 and S422, which are similar to the corresponding steps S404, S406, S408, S410 and S412.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for transforming three-dimensional measurement programs, the system comprising a first three-dimensional measurement machine applicable to a first measurement program, a second three-dimensional measurement machine applicable to a second measurement program, and a three-dimensional measurement program transforming device, the three-dimensional measurement program transforming device comprising:
a measurement program loading module for loading the first measurement program;
a parameter setting transforming module for transforming parameter settings of the first measurement program to parameter settings of the second measurement program;
a coordinate element transforming module for transforming coordinate elements of the first measurement program to coordinate elements of the second measurement program; and
a geometry element transforming module for transforming geometry elements of the first measurement program to geometry elements of the second measurement program.

2. The system according to claim 1, wherein the three-dimensional measurement program transforming device further comprises a determining module for determining a transforming direction of the loaded measurement program.

3. The system according to claim 1, wherein the three-dimensional measurement program transforming device further comprises a computing module for computing a height of a clear plane in each of the three-dimensional measurement programs.

4. The system according to claim 1, wherein the three-dimensional measurement program transforming device further comprises a storing module for storing the transformed three-dimensional measurement program as a file.

5. A method for transforming three-dimensional measurement programs, which transforms a first measurement program in a first three-dimensional measurement machine to a second measurement program in a second three-dimensional measurement machine, the method comprising the steps of:
loading the first measurement program;
establishing a transforming sequence; and
transforming each part of the first measurement program to corresponding part of the second measurement program.

6. The method according to claim 5, further comprising the step of determining a transforming direction of the loaded three-dimensional measurement program.

7. The method according to claim 5, further comprising the step of storing the transformed three-dimensional measurement program as a file.

8. The method according to claim 5, further comprising the step of computing a height of a clear plane in each of the measurement programs.
